(19) United States
(12) Patent Application Publication
(10) Pub. No.: US 2009/0012836 A1
(43) Pub. Date: Jan. 8, 2009

(54) Handling Exceptional Situations in a Warehouse Management

(76) Inventors: Steffen Weissbach, Dresden (DE); Oliver Radmanu, Hueffenhardt (DE); Stefan Grabowski, Osthofen (DE)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/096,359

(22) PCT Filed: Dec. 5, 2005
(86) PCT No.: PCT/EP2005/056494

§ 371 Date: Sep. 16, 2008

(51) Int. Cl. G06Q 10/00

(52) U.S. Cl. 705/9; 705/7; 705/8

(57) ABSTRACT

The invention provides methods and apparatus, including computer program products, for handling exceptional situations in a warehouse management. From a user application of the warehouse, an exception code is received, the exception code being representative of a predetermined exceptional situation in the warehouse. The exception code is verified as to validity, and if the received exception code is valid, a follow-up action based on the received exception code is automatically triggered.

### BACKGROUND OF THE INVENTION

This application relates to handling of exceptional situations in a warehouse management.

### STATE OF THE ART

Warehouse management is one of the tasks required in supply chain management. The supply chain, on the other hand, is a network of retailers, distributors, transporters, warehouses, and suppliers that take part in the production, delivery, and sale of a product or service.

Warehouse management systems are directed at making optimal use of the resources provided in a warehouse. A computer system keeps real-time track of resource use in the warehouse. Usual tasks within the warehouse are managed by transport orders, like the picking, stocking, or replacing of goods. The person who is actually doing the physical shifting of goods is provided with a simple order like “pick X goods of type Y from A and move them to B”.

It is desirable that the warehouse management system has complete and real-time knowledge of the goods, the flow of the goods, and the resources within the warehouse. This is supported by handheld units (a PDA or the like) for the picking person to receive transport orders or the like and report their completion. However, due to humans being involved, there will occur situations where the internal representation of the warehouse within the warehouse management system does not match reality. For example, the picking person receives a transport order to pick up 10 goods (usually, handling units) from a specified bin, which actually is empty.

### SUMMARY OF THE INVENTION

It is an object of the present invention to assist to deal with situations where the internal representation of the warehouse management system does not match reality in a simple and fast way.

In general, in one aspect, this invention provides a method for handling exceptional situations in a warehouse, the method comprising the steps of:
receiving, from a user application of the warehouse, an exception code, the exception code being representative of a predetermined exceptional situation in the warehouse;
verifying the received exception code as to validity; and
if the received exception code is valid, automatic triggering a follow-up action based on the received exception code.

In an alternative embodiment with a user selection, this invention provide a method for handling exceptional situations in a warehouse, the method comprising the steps of:
providing a plurality of exception codes to a user application of the warehouse, each exception code being representative of a predetermined exceptional situation in the warehouse;
receiving, from the user application, a selected one of the plurality of exception codes; and
automatic triggering a follow-up action based on the received exception code.

Advantageous implementations can include one or more of the following features.

In an embodiment, the exception code is generated in the user application in a first context and the triggered follow-up action is processed in a second context. Error detection and the measure for error handling can be separated that way.

In an embodiment, the exception code is generated upon detection of an exceptional situation in the warehouse. This special type of exceptional situation matches the needs of error handling in a warehouse.

In an embodiment, the plurality of exception codes which are provided to the user application are dependent on at least one of the type of user application, and the profile of a user working with the user application. The possible exception handling can be matched to the actual situation and to the competence of the user.

In an embodiment, an exception handling procedure signal is generated corresponding to the triggered follow-up action. This signal may be used for communication between the first and the second context.

In an embodiment, the user application is part of a product picking environment. This is one of the preferred fields where the invention can advantageously be used.

In an embodiment, at least one exception code is transmitted via RF. This allows for higher flexibility for the user involved, especially a picker.

In an embodiment, the user application works in an RF environment. This even increases the independence of the user.

In an embodiment, the follow-up action comprises connecting to at least one of status managing, alert managing, workflow processing systems. These are three important classes of exception handling accommodating the possible exceptions that might occur.

In an embodiment, exception handling is encapsulated in the user application. This feature provides the advantage of easier integration into existing systems.

In an embodiment, a skill level number is assigned to each possible handling procedure and the presented and/or selectable possible exception handling procedures depend on a matching of a predefined skill level criterium. Then, the possible exception handling procedures that are triggered match the competence of the user.

In an embodiment, the skill level numbers represent a hierarchy, and the criterium is a minimal or a maximal skill level number. This is an easy representation of user competence.

In an embodiment, a number of user profiles is given, the plurality of exception codes to be provided to the user application is obtained by filter operation from a data base of exception codes, based on a selected one of the number of user profiles. This is a more involved, but custom-designed and more flexible representation of user competence.

In an embodiment, the plurality of exception codes are transmitted via RF to a handheld device of the user application. This makes the user more flexible, and frees the handheld device of too much storage and/or processing requirements.

The apparatus of the invention provides similar features and advantages, as are defined by the respective dependent claims.

In particular, the invention comprises also computer systems for performing the inventive methods.

Furthermore, the invention comprises computer-readable storage media comprising program code for performing the inventive methods, when loaded into a computer system.

One of the advantages is that the present invention allows the user (picking person) to meet the problem of a mismatch between the transport order and the real situation at once. Without more effort than a user selection, a resolving process is triggered. Moreover, the warehouse management system can immediately respond to the inconsistency and update its internal representation. Then, the gap between internal representation and reality is kept as small as possible.

### BRIEF DESCRIPTION OF DRAWINGS

The invention will be described in detail below with reference to the included Drawings and to further features and advantages of the invention. The Drawings show in

FIG. 1 a design overview of the elements of an embodiment of the invention;

FIG. 2 an illustrative diagram showing signals exchanged in an embodiment of the invention;

FIG. 3 a flowchart of a method according to an embodiment of the invention;

FIG. 4 a flowchart of an alternative method according to an embodiment of the invention;

FIG. 5 a flow chart illustrating part of an inventive embodiment where the appropriate exception code signals are determined;

FIG. 6 a flow chart illustrating part of an inventive embodiment where an exception code signal is verified; and

FIG. 7 a flow chart illustrating part of an inventive embodiment where the action following reception of an exception code signal is started.

### DETAILED DESCRIPTION

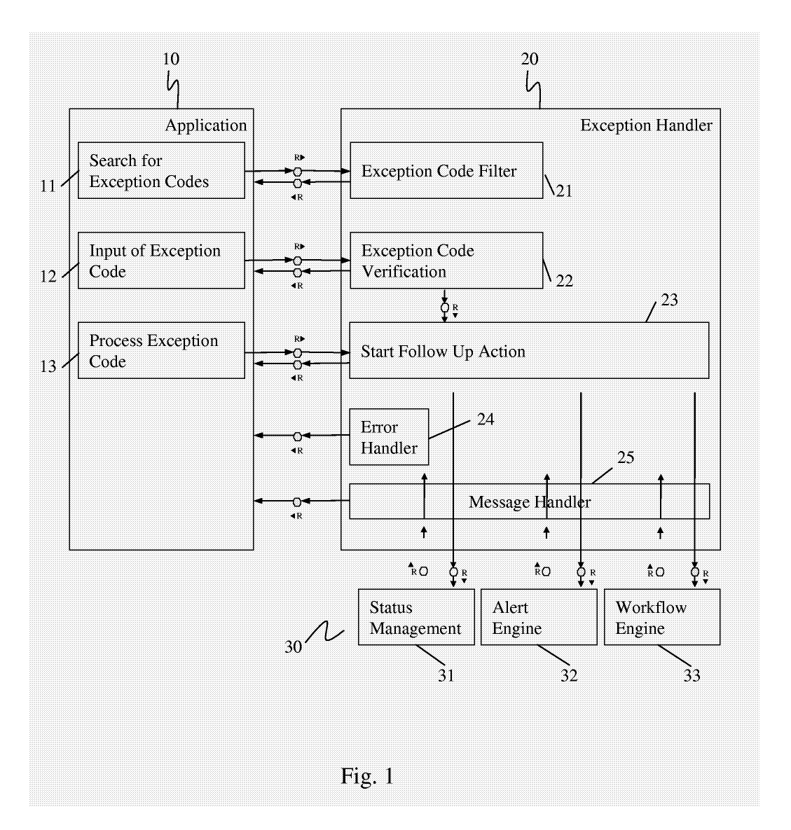

FIG. 1 shows elements of an embodiment of the invention in a design overview. The design is intended to become part of a warehouse management system which will not be described in any detail. On the application's 10 side, the appropriate response to an exceptional situation is selected in communication with a preferably, but not necessarily encapsulated exception handler 20. The exception handler 20, after having received an exception code in cooperation with application 10, may automatically trigger one of the follow-up actions 30.

Here and in the following, an exceptional situation is understood to be any problem stemming from a command given by the warehouse management system to a user that cannot actually be executed. The reason for this impossibility is assumed to mainly be an inconsistency of the internal warehouse representation of the warehouse management system and the real world. Of course, there are also other possibilities like errors within the warehouse management system itself.

The typical example of an exceptional situation is a transport order given to a picking person that cannot be executed. He might be asked to pick up a certain number of handling units from a specified bin, which actually is empty. Or the transport order requests him to store a number of handling units within a bin without sufficient capacity. Or the bin is temporarily inaccessible for any reason. These are only two out of a huge magnitude of possibilities.

The application 10 may be a picking order management system or the like. As a first additional component according to the invention, the picking order management system comprises means 11 that search for exceptional codes in combination with exception code filter means 21 of the exception handler 20. Filtering is useful if the concerned picking person should not be confronted with all possible exceptions known to the system. Instead, means 11 and filter 21 provide context-related exception codes that may occur in execution of the current transport order. For example, for the picking person confronted with a bin without sufficient capacity to store the handling units as requested any exception handling related to replenishing of the goods to be transported is of no help at all.

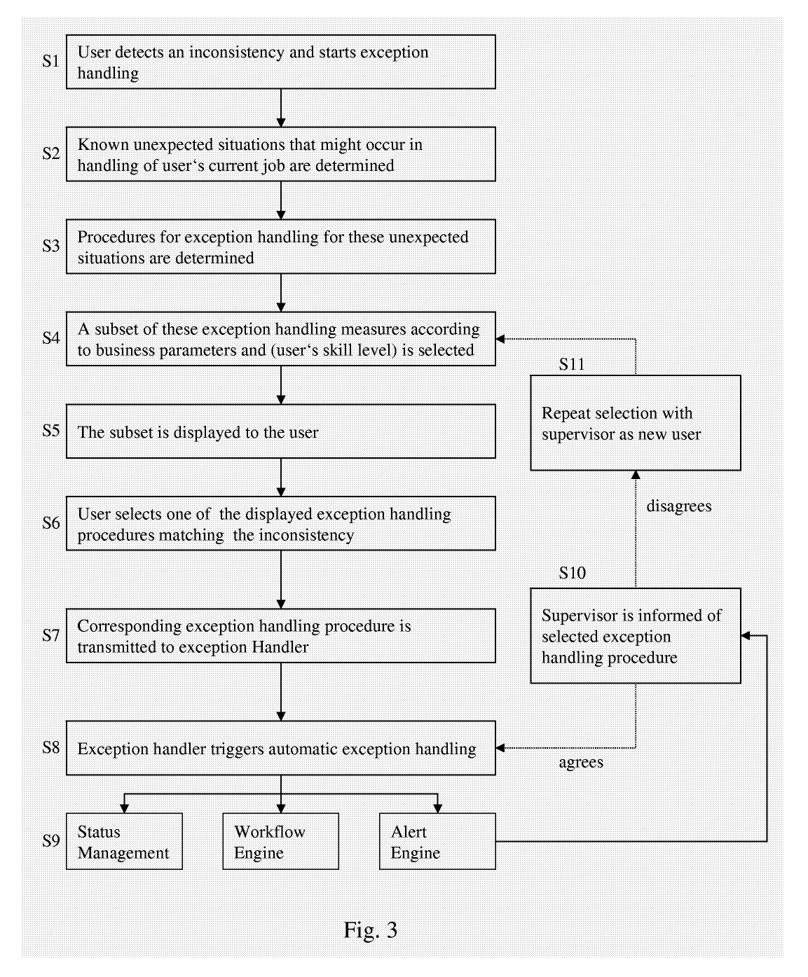

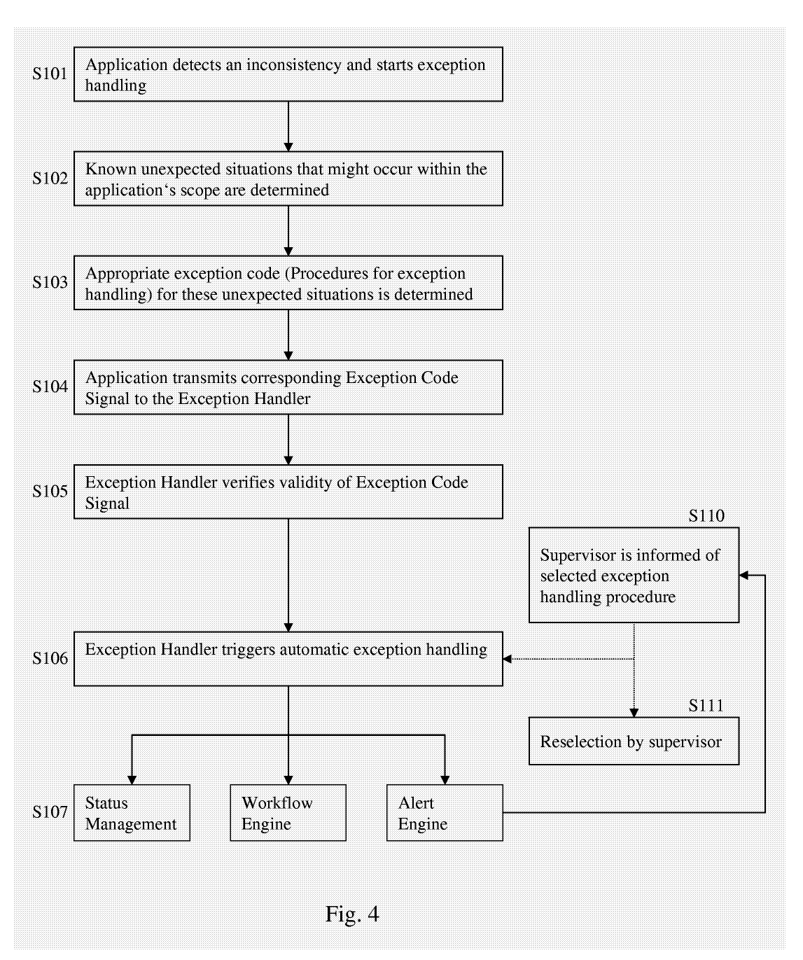

As another additional element the application 10 includes inputting means 12 for an exception code. As it will become more clear after description of embodiments with reference to FIGS. 3 and 4 below, an exception code may be either manually selected by the picking person or automatically by the application. The inputting means 12 communicate with means 22 for exception code verification of the exception handler 20. Verification of an exception code may be as simple as checking whether it is a valid exception code and as complicated as checking whether the selected exception code is plausible and assumed to resolve the problem by the warehouse management system.

Means 13 for processing the exception code within the application 10 communicate with means 23 for starting a follow-up action of exception handler 20. Depending on the implemented method, means 13 may request a confirmation of an exception handling procedure selected by follow-up starting means 23 of the exception handler 20, or may interactively select an appropriate response to the exceptional situation, as will be explained below. In a completely automated embodiment, the exception code may be generated by inputting means 12, verified by verification means 22, triggering follow-up means 23 without the processing means 13 being involved at all.

In one embodiment, after an exception code is input via inputting means (12), a follow-up action is triggered immediately after the exception code has been verified (22). In an alternative embodiment, a follow-up action can also be triggered by processing means (13) at a later time, i.e. independent of exception code verification (22).

The exception handler 20 additionally comprises an error handler 24 capable of reporting to the application 10 and managing errors that occur during the exception handling. Furthermore, a message handler 25 is capable of sending messages to the application 10 and receiving messages from one of the follow-up actions 31, 32, 33.

As can be seen in FIG. 1, three classes of follow-up actions 30 may be discriminated. Firstly, a status management 31 may be commanded to modify status variables of the warehouse management objects (Bin, Handling Unit, . . . ). Among the examples for status variables are “damaged” for certain goods, “under construction” for certain parts of the warehouse or the like. As can be inferred from the examples, a status modification does not trigger any action, but modifies the internal representation of the warehouse management system in order for future measures to be informed about the actual situation.

Secondly, the exception code may be transmitted to an alert engine 32 where an appropriate alert is raised, which may be a message on a supervisor's display or any other conceivable form of alarm.

Thirdly, a workflow engine 33 may be triggered to start a workflow that was assigned and predefined to resolve the problem. This workflow may relate to reordering or shifting of goods or any other flow of actions.

Of course, the follow-up action may consist of a combination of these three classes. For example, when the workflow engine 33 starts to reorder a good, it can be meaningful to mark the bin as low on stock in the status management 31 and to send an alert message via alert engine 32.

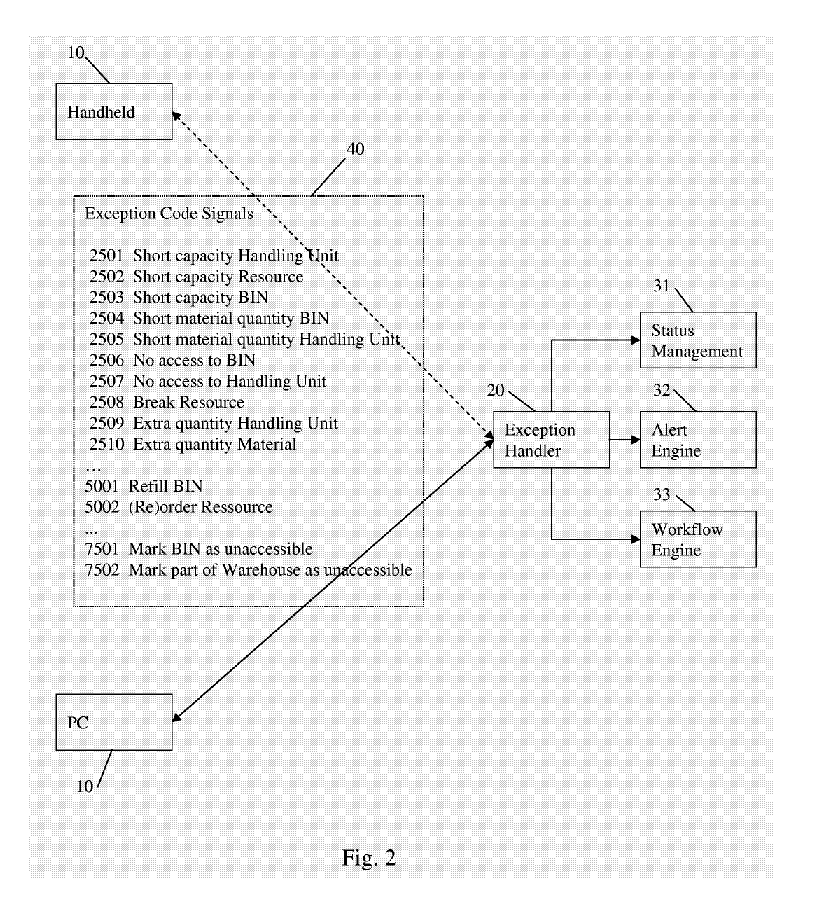

Following the overview description above, further details and variants of the system will now be described. FIG. 2 shows an explanatory diagram of signals exchanged in an embodiment of the invention. Parts of the application 10 may preferably be run on a handheld unit of a picking person, like a PDA or a notebook. In order to allow the picking person's free action, the handheld is preferably used in an RF environment, i.e. has a wireless connection (dotted lined arrow) to other parts of the warehouse management system like a server. Nevertheless, it is also conceivable to run the application on a stationary computer system connected via ethernet or an equivalent (solid lined arrow). Finally, both components may be in use, with part of the application 10, the exception handler 20, and the follow-up components status management 31, alert engine 32, and workflow engine 33 running on a handheld, a PC, and/or a server each.

The grey shaded rectangle shows examples for exception code signals 40 exchanged between the application 10 and the error handler 20. Without any restrictions implied, each error code is assigned a four-digit number. Of course, any other known coding scheme can be used as well. Here, the three classes of follow-up actions are coded in the first two digits. Codes starting with 25 are alert messages, codes starting with 50 are workflows, and codes starting with 75 are status modifications. Again, this is an example and may be exchanged with any other coding scheme.

The meaning of the codes 40 should be clear from their names. Anyway, these are only examples of exception codes that may occur in a warehouse management system. Any additional exceptional situation may be included by assigning an exception code signal and an appropriate status modification, alert message, and/or workflow.

FIG. 3 shows a flow chart of a method of an embodiment of the invention with interactive selection of an exception code signal. In a first step S1, a user (normally, but not necessarily a picking person) detects an inconsistency that necessitates exception handling. As already described, the inconsistency may relate to a mismatch of the internal warehouse management system's representation and the actual situation. In any case, the picking person is unable to execute his order because the situation makes it impossible. Therefore, he starts the exception handling e.g. by calling the exception handling tool on his handheld. It should be repeated that a stationary PC, a notebook or the like can also be used.

The means 11 for exception code searching in the application 10 determine in a step S2 Systems known unexpected situations that might occur in handling of the picking person's current transport order, in cooperation with exception code filter 21 of the exception handler 20. Apart from a frontend that necessarily has to be present on the picking person's handheld, any of these components may be installed on the handheld and/or a server accessed via wireless data communication.

In a step S3, the exception handler 20 prepares a list of exception handling procedures for the unexpected situations as determined. This process can be interactively supported by the input means 12 where the picking person selects one of the possible unexpected situations prior to selecting any exception handling procedure. In that case, verification means 22 may check the validity and/or plausibility of the exception code corresponding to the selected unexpected situation.

In a step S4, the exception handling procedures are filtered with respect to the user's skill level. Here, only exception handling procedures remain that match the user's profile. As an extreme example, shut down of whole parts of the warehouse due to a detected water leakage should not be accessible to each of the workers and is removed due to his profile. On the other hand, the responsible warehouse manager as a user should be able to access all possible exception handling procedures.

In a step S5, the subset of exception handling procedures is displayed to the user, preferably by displaying a table within the application 10 on the user's handheld. Then, in a step S6, the user selects one of the exception handling procedures. In a step S7, the selected exception handling procedure is communicated to the follow-up starting means 23 of exception handler 20. The selection process S6, S7 may also be accompanied by a communication of process means 13 and follow-up starting means 23, for example determined in a hierarchical sequence of selections and/or confirmation requests. Moreover, if an error occurs during the procedure, error handler 24 may stop the process and/or start a recovery mechanism.

In a step S8, the exception handler 20 triggers the automatic exception handling according to the selected exception handling procedure. To that end, follow-up starting means 23 trigger the required functions as a final step 9 of one of status management 31, alert engine 32, and/or workflow engine 33. Any response messages of the follow-up applications may be transmitted to the user by message handler 25.

The dotted lined arrows illustrate the flow in case of a variant of the embodiment as described. Here, the alert engine informs a supervisor of the user in a step S10 of the selected exception handling procedure.

Then, the supervisor may approve the selected procedure and the method may continue with the follow-up action in step S8. On the other hand, the supervisor may disagree. In that case, the method stops. As an alternative, the supervisor himself repeats the selection method in a step S11, starting from the display of a subset of possible exception handling procedures in step S4. It should be noted that, with the supervisor as user, the subset of displayed exception handling procedures is different and probably larger than originally. It should also be noted that, in principle, the control loop as described can be iterated with a supervisor of the supervisor, and so on.

FIG. 4 shows a flow chart of an alternative method of an embodiment of the invention with automated selection of an exception code signal. Here, the exception code is generated internally in the application rather than by input of the user. Variants, however, and details described in the context of FIG. 3 can be used in an identical or analogous way. A combination of interactive and automated selection according to the embodiments described with reference to FIGS. 3 and 4 is also possible.

In a first step S101, the application detects an inconsistency and starts exception handling. The meaning of inconsistency has already been defined.

In a step S102, known unexpected situations that might occur within the application's scope are determined. This can be determined by the application alone, or by a combination of search means 11 of the application and filter means 21 of the exception handler.

Exception handling procedures for these unexpected situations are determined in a step S103. A corresponding exception code signal is transmitted to the exception handler 20 in a step S104, where it is verified and/or checked for plausibility in a step S105. Instead of in the application alone, steps S103 to S105 can also be processed in a cooperation of input means 12 (here, the term “determination means” might be more exact as no user interaction takes place) of the application 10 and verification means 22 of exception handler 20.

After verification, in a step S106 the follow-up starting means 23 immediately and automatically trigger the appropriate action in at least one of status management 31, alert engine 32, and/or workflow engine 33 (step S107).

Symbolized by dotted lines and arrows, an optional authorisation by a supervisor analogous to the embodiment described with reference to FIG. 3 is illustrated. In a step S110, a supervisor is informed of the selected exception handling measure by the alert engine 32. Then, the supervisor may approve the exception handling procedure, with the method continuing at step S106 triggering the follow-up action. The supervisor may also stop the exception handling procedure, and the method terminates. Finally, he may decide to reselect the exception handling procedure (S111). In that case, the method according to the embodiment as described with reference to FIG. 3 is invoked with the supervisor interactively selecting an exception handling procedure.

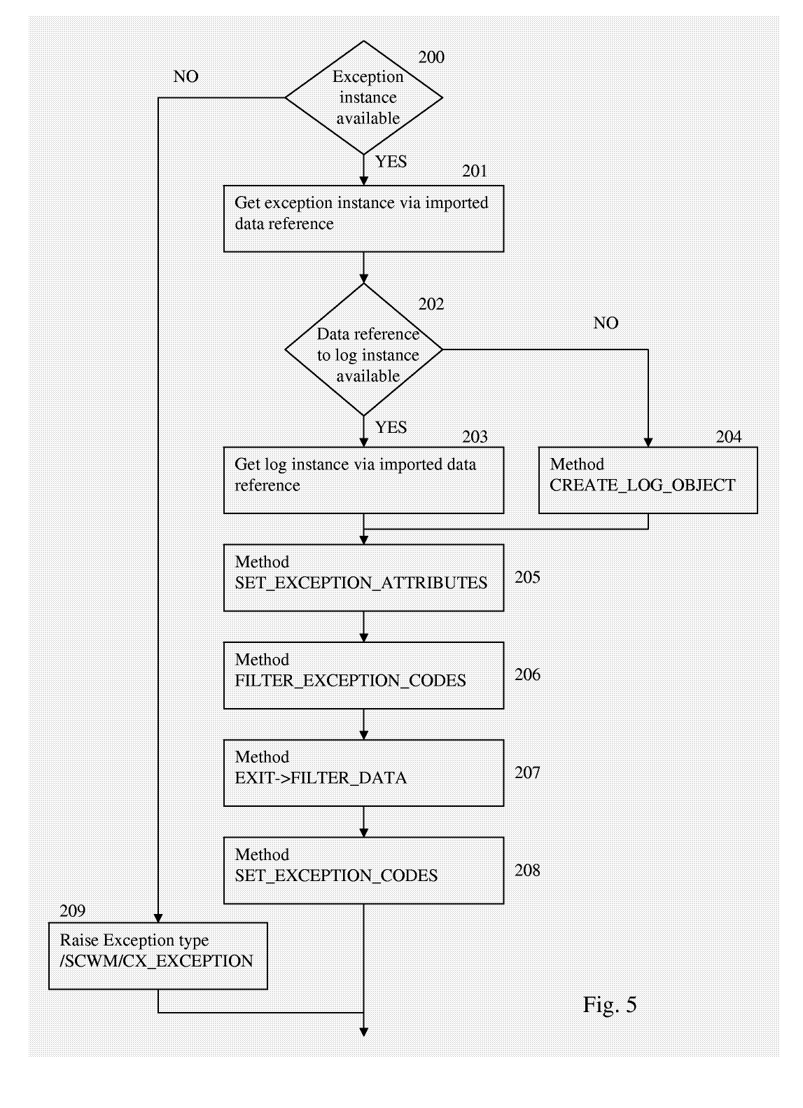

FIGS. 5 to 7 show flow charts of parts of embodiments of the invention. Class definition and the flow of method calls is to be understood as an implementation example and does not restrict the scope of the invention as described in the more general embodiments above.

FIG. 5 shows a flow chart of a method to get appropriate exception codes. The detailed implementation of FIG. 5 has not necessarily to be used for the above embodiments.

As a first check 200, the availability of the exception instance is checked. If this is the case, the exception instance is accessed via an imported data reference (201). In the other case, the method terminates with an exception 209 called, for applicant's internal reasons, /SCWM/CX_EXCEPTION. The simple meaning is that no exception handler can be accessed.

As a second check 202, it is checked whether a data reference to a log instance is available. If so 203, the log instance is accessed by an imported data reference. In the other case 204, a log instance is created with a call of the method CREATE_LOG_OBJECT. After steps 202-204, it is assured that a valid log instance used to log the exception handling for later reference is present. If no logging is necessary, these steps 202-204 can, of course, be omitted.

A call 205 of the method SET_EXCEPTION_ATTRIBUTES transfers the current parameters to the imported instance of the exception handler object (cf. step 200/201). These parameters may include a business context (like transport order creation, transport order confirmation), the process step (like moving to bin, picking from bin), the process mode (RF, online, batch), warehouse number, workflow attributes, and more.

Afterwards, by calling 206 FILTER_EXCEPTION_CODES, all appropriate exception codes including a description according to parameters like warehouse number, business context, and process step are provided.

The call 207 of EXIT->FILTER_DATA is optional and allows to custom-design the filtering and refine the filtering of step 206.

With a call 208 of SET_EXCEPTION_CODES, the filtered valid exception codes are transferred to the related attribute of the exception instance.

Then, all possible valid and relevant exception codes have been determined.

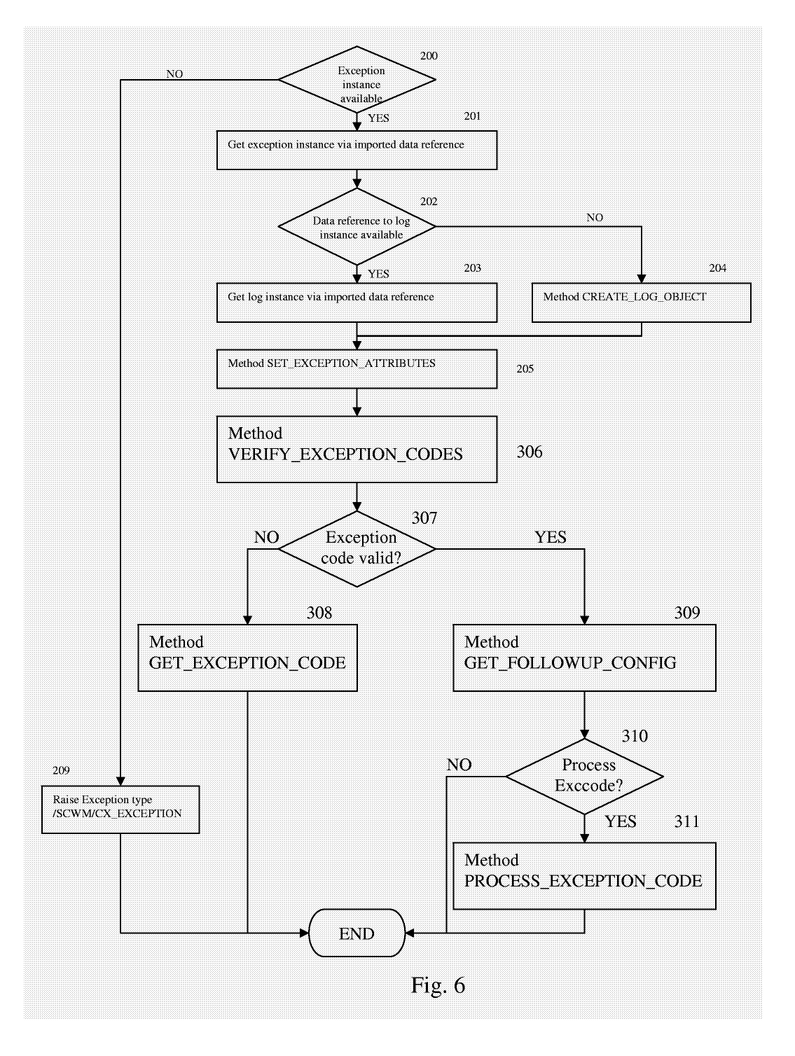

FIG. 6 shows a flow chart of a method to verify exception codes. The detailed implementation of FIG. 6 has not necessarily to be used for the above embodiments.

Steps 200-205 and 209 are identical to the corresponding steps illustrated in FIG. 5, and a repetition of the description will be omitted. With a call 306 to VERIFY_EXCEPTION_CODES, the imported exception code generated by application 10 will be checked against entries which are available in customizing a table of valid exception codes. If the exception code is valid at this point of process, a validation flag will be set. It has already been pointed out that more complicated plausibility checks are conceivable at this point. This validity flag is checked 307.

If the exception code is invalid 308, the method GET_EXCEPTION_CODE according to the description with reference to FIG. 5 is called. In the other case 309, a Method GET_FOLLOWUP_CONFIG is called to select the configuration data of follow up actions. These follow-up actions may be customized in advance. If an exception profile is maintained, i.e. if exception handling procedures are filtered according to the user's skill level as described above, and the profile restricts access to special user ID's, the follow-up action will be checked against the exception creator, i.e. the person that has triggered the exception handling. If no profiles are maintained, all users will have access to all exception handling procedures as a default.

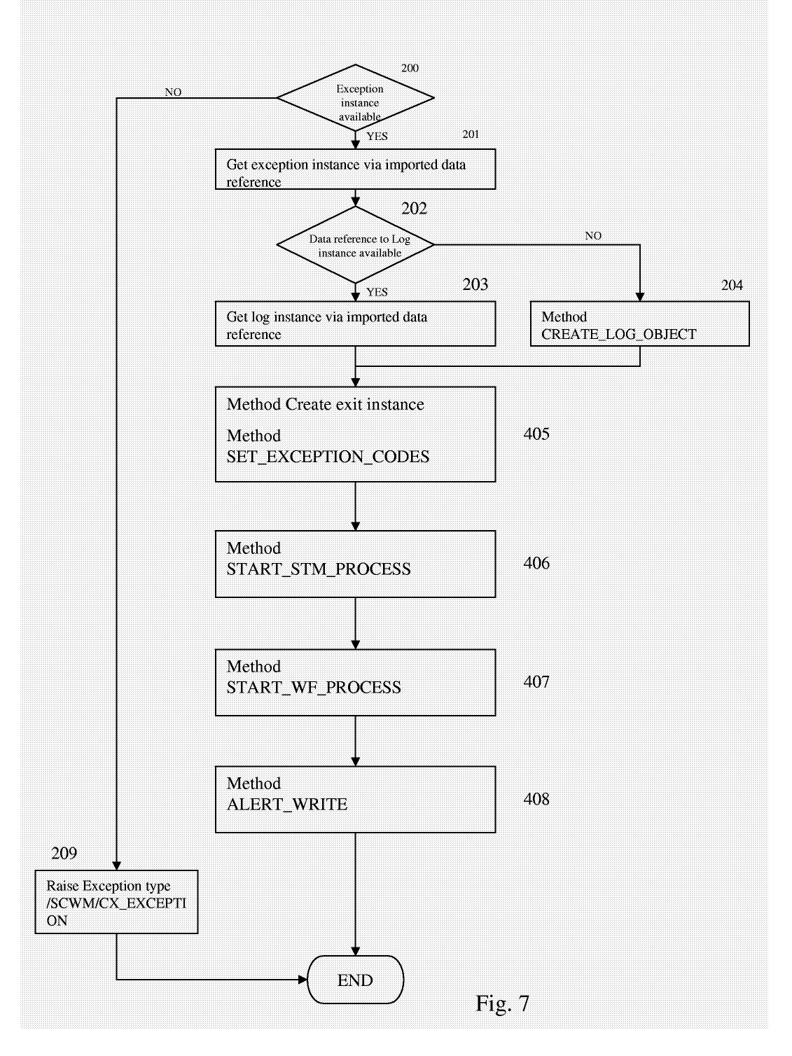

It is checked 310 whether the exception handling procedure should be processed. If not, the method terminates. In the other case 311, method PROCESS_EXCEPTION_CODE is called that will now be described with reference to FIG. 7.

FIG. 7 shows a flow chart of a method to trigger a follow up action. The detailed implementation of FIG. 7 has not necessarily to be used for the above embodiments.

Again, steps 200-204 and 209 are identical to those described above, and a repetition of their explanation will be omitted. In a step 405, an exit instance is created and a method START_ACTION called. This is but an anchor for custom-designed actions and, in a default version, does nothing.

Then, a method START_STM_PROCESS is called 406. Here, the status management 301 is requested to perform the required status modification. In case that the status cannot be changed, information of the failure will preferably be transferred to the application 10 by message handler 25.

Afterwards, a method START_WF_PROCESS is called 407 to start a workflow with help of workflow engine 33. Therein, the workflow environment data is transmitted and the connected workflow is started. Again, messages relating to failure or others can be displayed to the user via message handler 25 and application 10.

With a call to a method ALERT_WRITE, the appropriate alert messages are selected and prepared to raise an alarm with help of alert engine 32.

It should be noted that any call to one of the follow-up invoking methods 406-408 may be looped to repeat them from 0 to n times. As generally known, a loop repeated for zero times means that the method is not called at all. With that mechanism, any combination of status modification, workflow, and/or alert may be invoked.

Afterwards, the method PROCESS_EXCEPTION_CODE illustrated in FIG. 7 terminates.

With the invention as described above, it is possible to keep the gap between real world (physical warehouse) and system data (warehouse management system) small at all times. Any detected inconsistency can be entered in the system as soon as possible. With the exception handling service, the user is able to describe the problem he has to face by entering the appropriate exception code. With help of that exception code, either automatically or after selection of the user, an appropriate exception handling can be triggered. Different functions like status management, alerts, or a workflow can be started immediately.

The qualified information of the detected inconsistency can be logged and saved in a database. Therefore, it is possible to monitor and trace all exception information. The exception handler may be encapsulated and work with the application on the one hand and the follow-up system on the other with none or only minimal modification of these systems. These linkages are configurable to meet the requirements.

The exceptional situation can be solved system-supported. Complex background and/or foreground tasks are processed to eliminate the detected inconsistency. Depending on the user's skill level, the single exception handling procedures may be only small or of large consequence. In any case, no deeper understanding of the consequences is required, but can optionally be included by a supervisor overriding the system's decision.

The present techniques can be implemented in digital electronic circuitry, or in computer hardware, firmware, software, or in combinations of them. Apparatus of the invention can be implemented in a computer program product tangibly embodied in a machine-readable storage device for execution by a programmable processor. Method steps according to the invention can be performed by a programmable processor executing a program of instructions to perform functions of the invention by operating on the basis of input data, and by generating output data. The invention may be implemented in one or several computer programs that are executable in a programmable system, which includes at least one programmable processor coupled to receive data from, and transmit data to, a storage system, at least one input device, and at least one output device, respectively. Computer programs may be implemented in a high-level or object-oriented programming language, and/or in assembly or machine code. The language or code can be a compiled or interpreted language or code. Processors may include general and special purpose microprocessors. A processor receives instructions and data from memories, in particular from read-only memories and/or random access memories. A computer may include one or more mass storage devices for storing data; such devices may include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by or incorporated in ASICs (application-specific integrated circuits).

The computer systems or distributed computer networks as mentioned above may be used, for example, for producing goods, delivering parts for assembling products, controlling technical or economical processes, or implementing telecommunication activities.

To provide for interaction with a user, the invention can be implemented on a computer system having a display device such as a monitor or LCD screen for displaying information to the user and a keyboard and a pointing device such as a mouse or a trackball by which the user can provide input to the computer system. The computer system can be programmed to provide a graphical or text user interface through which computer programs interact with users.

A computer may include a processor, memory coupled to the processor, a hard drive controller, a video controller and an input/output controller coupled to the processor by a processor bus. The hard drive controller is coupled to a hard disk drive suitable for storing executable computer programs, including programs embodying the present technique. The I/O controller is coupled by means of an I/O bus to an I/O interface. The I/O interface receives and transmits in analogue or digital form over at least one communication link. Such a communication link may be a serial link, a parallel link, local area network, or wireless link (e.g. an RF communication link). A display is coupled to an interface, which is coupled to an I/O bus. A keyboard and pointing device are also coupled to the I/O bus. Alternatively, separate buses may be used for the keyboard pointing device and I/O interface.

1-31. (canceled)

32. A method for handling exceptional situations in a warehouse, the method comprising:
receiving, from a user application of the warehouse, an exception code, the exception code being representative of a predetermined exceptional situation in the warehouse;
verifying the validity of the received exception code; and
if the received exception code is valid, automatic triggering a follow-up action based on the received exception code.

33. The method according to claim 32,
wherein the exception code is generated in the user application in a first context and the triggered follow-up action is processed in a second context.

34. The method according to claim 32,
wherein the exception code is generated upon detection of an exceptional situation in the warehouse.

35. The method according to claim 32,
wherein an exception handling procedure signal is generated corresponding to the triggered follow-up action.

36. The method according to claim 32, wherein the user application is part of a product picking environment.

37. The method according to claim 32, wherein at least one exception code is transmitted via RF.

38. The method according to claim 32, wherein the user application works in an RF environment.

39. The method according to claim 32, wherein the follow-up action comprises connecting to at least one of status managing, alert managing, workflow processing systems.

40. The method according to claim 32, wherein exception handling is encapsulated in the user application.

41. The method according to claim 32, wherein a skill level number is assigned to each possible handling procedure and the presented and/or selectable possible exception handling procedures depend on a matching of a predefined skill level criterium.

42. The method according to claim 41, wherein the skill level numbers represent a hierarchy, and the criterium is a minimal or a maximal skill level number.

43. A method for handling exceptional situations in a warehouse, the method comprising:
providing a plurality of exception codes to a user application of the warehouse, each exception code being representative of a predetermined exceptional situation in the warehouse;
receiving, from the user application, a selected one of the plurality of exception codes; and
automatically triggering a follow-up action based on the received exception code.

44. The method according to claim 43, wherein the plurality of exception codes which are provided to the user application are dependent on at least one of the type of user application, and the profile of a user working with the user application.

45. The method according to claim 43, wherein a number of user profiles is given, the plurality of exception codes to be provided to the user application is obtained by filter operation from a data base of exception codes, based on a selected one of the number of user profiles.

46. The method according to claim 43, wherein the plurality of exception codes are transmitted via RF to a handheld device of the user application.

47. An apparatus for handling exceptional situations in a warehouse, the apparatus comprising the steps of:
receiving means that receive, from a user application of the warehouse, an exception code, the exception code being representative of a predetermined exceptional situation in the warehouse;
verification means that verify the received exception code as to validity; and
triggering means that, if the received exception code is valid, automatically trigger a follow-up action based on the received exception code.

48. The apparatus according to claim 47, wherein the exception code is generated in the user application in a first context (10) and the triggered follow-up action is processed in a second context (20).

49. The apparatus according to claim 47, further comprising generating means that generate the exception code upon detection of an exceptional situation in the warehouse.

50. An apparatus for handling exceptional situations in a warehouse, the apparatus comprising:
provision means that provide a plurality of exception codes to a user application of the warehouse, each exception code being representative of a predetermined exceptional situation in the warehouse;
receiving means that receive, from the user application, a selected one of the plurality of exception codes; and
triggering means that automatically trigger a follow-up action based on the received exception code.

51. The apparatus according to claim 50, wherein the plurality of exception codes which are provided to the user application are dependent on at least one of the type of user application, and the profile of a user working with the user application.

52. The apparatus according to claim 50, wherein an exception handling procedure signal is generated corresponding to the triggered follow-up action.

53. The apparatus according to claim 50, wherein the user application (10) is part of a product picking environment.

54. The apparatus according to claim 50, further comprising RF means that transmit at least one exception code via RF.

55. The apparatus according to claim 50, wherein the user application works in an RF environment.

56. The apparatus according to claim 50, wherein the follow-up action comprises connecting to at least one of status managing, alert managing, workflow processing systems.

57. The apparatus according to claim 50, wherein exception handling is encapsulated in the user application.

58. The apparatus according to claim 50, wherein a skill level number is assigned to each possible handling procedure and the presented and/or selectable possible exception handling procedures depend on a matching of a predefined skill level criterium.

59. The apparatus according to claim 58, wherein the skill level numbers represent a hierarchy, and the criterium is a minimal or a maximal skill level number.

60. The apparatus according to claim 50, wherein a number of user profiles is given, the plurality of exception codes to be provided to the user application is obtained by filter operation from a data base of exception codes, based on a selected one of the number of user profiles.

61. The apparatus according to claim 50, wherein the plurality of exception codes are transmitted via RF to a handheld device of the user application.

62. A computer readable medium having program code stored therein that when executed by a processor cause the processor to:
determine a possible lot size of units with respect to a fixed date for a chain of at least two sequentially dependent process steps, each process step requiring a respective assigned resource by:
receiving, from a user application of the warehouse, an exception code, the exception code being representative of a predetermined exceptional situation in the warehouse;
the validity of verifying the received exception code; and
automatically triggering a follow-up action based on the received exception code if the received exception code is valid.
